(19) United States
(12) Patent Application Publication
(10) Pub. No.: US 2018/0088234 A1
(43) Pub. Date: Mar. 29, 2018

(54) Robust Localization and Localizability Prediction Using a Rotating Laser Scanner

(71) Applicant: CARNEGIE MELLON UNIVERSITY, Pittsburgh, PA (US)

(72) Inventors: Sebastian Scherer, Pittsburgh, PA (US); Weikun Zhen, Pittsburgh, PA (US); Sam Zeng, Pittsburgh, PA (US)

(21) Appl. No.: 15/717,578

(22) Filed: Sep. 27, 2017

Related U.S. Application Data
(60) Provisional application No. 62/495,863, filed on Sep. 27, 2016.

(51) Int. Cl. G01S 17/02; G01S 17/42; G01S 17/58; G01S 17/89

(52) U.S. Cl. CPC G01S 17/023; G01S 17/42; B64C 39/024; G01S 17/89; G01S 17/58

(57) ABSTRACT

A robust localization approach for UAVs that fuses measurements from inertial measurement unit (IMU) and a rotating laser scanner is described. An Error State Kalman Filter (ESKF) is used for sensor fusion and is combined with a Gaussian Particle Filter (GPF) for measurements update. Additionally, a new method to evaluate localizability of a given 3D map is described to show that the computed localizability can precisely predict localization errors, thus helping to find safe routes during flight.

### RELATED APPLICATIONS

This application claims the benefit of U.S. Provisional Patent Application No. 62/495,863, filed Sep. 27, 2016.

### Government Rights

This invention was made with government support under IIS1328930 awarded by the National Science Foundation. The government has certain rights in the invention.

### TECHNICAL FIELD

Embodiments herein generally relate to the field of autonomous aerial vehicles, and, more particularly, to localization for autonomous micro-aerial vehicles.

### BACKGROUND OF THE INVENTION

There is a fast-growing demand for small unmanned aerial vehicles (UAVs) in industry for purposes of autonomous exploration and inspection. The compact form-factor, ease of control and high mobility of the UAV make them well suited for many tasks that are difficult for humans, due to limited space or potential danger. However, this also requires that the UAV system be robust enough to handle multiple tasks in challenging situations such as lowlight, GPS-denied, cluttered or geometrically under-constrained environments.

To achieve robustness, state estimation algorithms must produce high quality results in challenging situations. A common solution to this problem is increasing the redundancy of the sensing system. A diverse set of sensors tend to capture more useful information, especially if they are of different modalities. However, sensor redundancy creates new problems of its own, such as synchronization issues and payload constraints. Therefore, sensing system design must be a trade-off between redundancy and payload cost.

Popular solutions for robot localization can be divided into two categories: filtering-based approaches and optimization-based approaches. Filtering-based approaches (e.g. Bayesian filtering) infer the most likely state from available measurements and uncertainties, while optimization-based approaches attempt to minimize reprojection error to find the optimal states. As an objective of this invention is to specify an online algorithm capable of accurately localizing a UAV with limited onboard computing power, the filtering approach is preferred, as it is usually faster than iterative optimization procedures.

### DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram showing the localization process.

FIG. 2 is a graphic representation of the localization process.

FIG. 3 is a graphic representation of the calculation of the localizability metric based upon surface normals with respect to a laser striking a surface.

FIG. 4 is an example of an environment showing areas of localizability and non-localizability.

### SUMMARY OF THE INVENTION

Current localization methods, while being quite robust, are not always able to perform accurately throughout the entire configuration space for all environments. The main constraint on localization is often a result of the geometry of the map that the robot is being localized to. Some parts of a given environment may not offer enough planer surfaces to fully constrain the state estimation. When localization fails, the robot is not only incapable of performing its mission, but it is also exposed to significant flight risks, such as crashes or flyaways. To increase the robustness of the system as a whole, the present invention describes a reactive planning layer that prevents the robot from entering regions of space where localization failure is likely.

Localizability of space can be determined based on the geometric constraints of the map that the robot is using to localize. Specifically, localizability can be estimated based on the presence of planes in a given environment. Each plane constrains the pose estimate along its normal. Based on this, localizability can be estimated for a given pose in a map by computing a surface normal for every point on a map, and then ray tracing from the given pose to determine the number of visible planes from that pose. Based on the normals that are visible from this position, the direction which is least constrained for localization can be calculated using a singular value decomposition. Additional normalization can be applied to the localizability estimate to allow it to give consistent and bounded predictions about the localization performance.

The present invention uses an implementation of ESKF-based localization algorithm which is suitable for different sensing systems. For example, cameras or 3D LiDAR can be easily integrated into this framework. Second, the present invention describes a novel method for real time localizability estimation in 3D. This model is demonstrated by observing a correlation between predicted localizability and real pose estimation errors.

The ESKF filtering procedures and the localizability estimation algorithm are discussed in detail below.

### DETAILED DESCRIPTION

The robot localization system of the present invention comprises a quadcopter having an Inertial Measurement Unit (IMU) to capture fast motion, and a rotating laser to scan 3D environment and provide a global reference for localization. While the invention is described in terms of a quadcopter, it should be realized that the system may be applicable for any type of robot, for example, a UAV. This system is light and thus does not overburden the robot. Additionally, it can be packaged and used as a complete module, thus allowing easy transfer between platforms. The system is capable of capturing fast motion as well as maintaining a global reference to avoid drifting. The laser scanner (i.e., a LIDAR unit) can provide accurate range data even in bad illumination surroundings, where visual approaches would otherwise fail. The system includes an algorithm to predict the performance of the localization for any given location in a map, to avoid positioning the robot in areas where the localization is likely to fail.

### Estimation Formulation

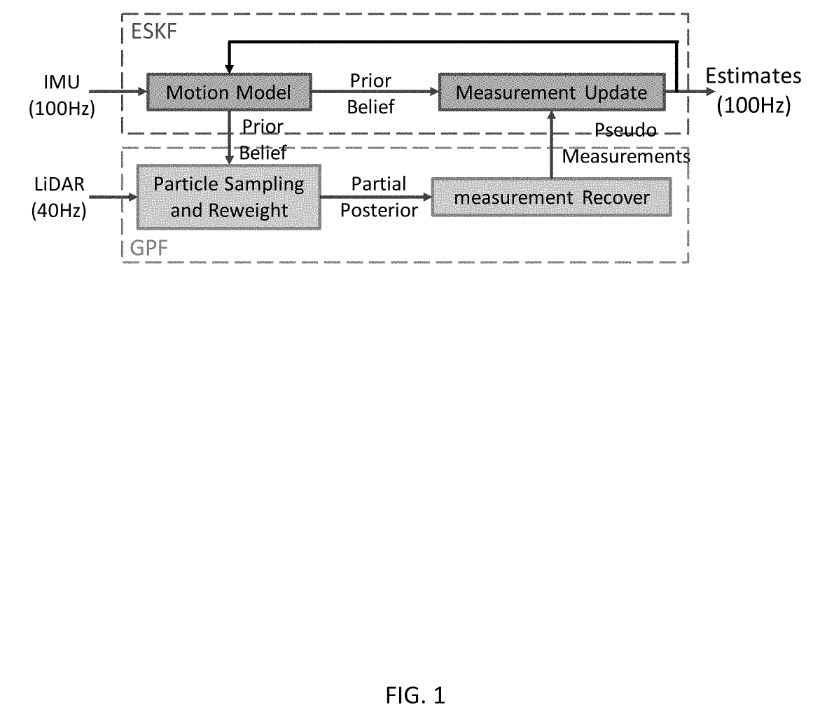

Given a pre-built map and the initial pose of the robot, its current pose, velocity and IMU biases are estimated immediately when a new set of range data is available. The localization is achieved by combining an Error State Kalman Filter (ESKF) with a Gaussian Particle Filter (GPF), as shown in FIG. 1.

Assuming a 3D point cloud map has been built, the object of the present invention is estimating robot position, orientation and velocity with IMU and laser measurements. First, the IMU acceleration and angular velocity are integrated numerically to provide an update to a previous state of the robot to create a prior belief of the robot state. However, this prior belief is subject to drifts since IMU measurements are always corrupted with noise and biases. During the prediction step, the uncertainty increases. Second, when a laser range measurement which usually comes at a lower frequency than IMU, is available, the range information from the laser is used to correct the prior belief and results in a more accurate posterior estimation. The GPF is used for extracting pose information from raw laser range data (point cloud data in this case). In the correction step, a set of particles is drawn according to the prior pose belief, and a likelihood is computed for each particle and treated as a weight. A weighted mean and covariance are then computed to be the pose posterior. Note that normally, laser measurements only contain pose information, but pose only occupies a part of the state vector. Thus, this partial posterior is further used to recover a pseudo-pose measurement. This pseudo-measurement is then used to update the full state vector through a normal Kalman filter (KF) update step.

An error state representation, compared to a nominal state representation, has several benefits. First, error states are always close to zero, thus making it valid to approximate R(δθ) as I+[δθ]ₓ where [δθ]ₓ is the skew-symmetric operator. This approximation makes the derivatives of an exponential map easy to compute. Second, in an error state, the rotation error is represented as a 3D vector, which is more intuitive than other types of rotation representations such as matrix or quaternion. Additionally, a 3D vector is easily put in a state vector, while a rotation matrix does not fit and a quaternion requires additional efforts to propagate its uncertainties. Finally, as the rotation error is always close to zero, it is far from a singular configuration.

### Error States

The state vector of the system contains:
v: velocity in global frame
p: position in global frame
R: rotation matrix
a_{b}: accelerometer bias
ω_{b}: gyroscope bias

The true state, predicted state and error state are represented as x, \hat{x} and δx respectively and satisfy equation (1).

x=\hat{x}⊕δx (1)

where ⊕ indicates a generic composition. Also note that in error state, angle vector δθ is represented by a 3×1 vector as a minimal representation of rotation error.

### Error Dynamics

The system aerodynamics are derived from nominal state dynamics. The following is a true representation of true state x, estimated state \hat{x} and error state δx.

$$\begin{matrix}\dot{\hat{x}} = [ \begin{matrix}\dot{\hat{v}} \\ \dot{\hat{p}} \\ \dot{\hat{R}} \\ {\dot{\hat{a}}}_{p} \\ {\dot{\hat{ω}}}_{b}\end{matrix} ] = [ \begin{matrix}\hat{R} ( {a}_{m} - {\hat{a}}_{b} ) + g \\ \hat{v} \\ \hat{R} [ {ω}_{m} - {\hat{ω}}_{b} ] \times \\ 0 \\ 0\end{matrix} ] & ( 2 ) \\ δ x = [ \begin{matrix}δ \dot{v} \\ δ \dot{p} \\ δ \dot{θ} \\ δ {\dot{a}}_{b} \\ δ {\dot{ω}}_{b}\end{matrix} ] = [ \begin{matrix}- \hat{R} [ {a}_{m} - {\hat{a}}_{b} ] \times δ θ - \hat{R} δ {a}_{b} - \hat{R} {a}_{n} \\ δ v \\ - [ {ω}_{m} - {\hat{ω}}_{b} ] \times δ θ - δ {ω}_{b} - {ω}_{n} \\ {a}_{w} \\ {ω}_{w}\end{matrix} ] & ( 3 )\end{matrix}$$

Where aₘ, ωₘ is the acceleration and angular velocity measurements, aₙ, ωₙ denote accelerometer and gyroscope noise, and a_{w}, ω_{w} is the Gaussian random walk noise of biases.

### Propagation

The propagation step contains the estimated state propagation and the error covariance propagation. The estimate state is propagated through a direct Euler integration of equation (2), and the error covariance is propagated by linearizing the error state dynamics. Discrete propagation rule is shown in equations (4) and (5) respectively.

$$\begin{matrix}[ \begin{matrix}{\hat{v}}_{t + 1} \\ {\hat{p}}_{t + 1} \\ {\hat{R}}_{t + 1} \\ {\hat{a}}_{b ( t + 1 )} \\ {\hat{ω}}_{b ( t + 1 )}\end{matrix} ] = [ \begin{matrix}{\hat{v}}_{t} + [ {\hat{R}}_{t} ( {a}_{m} - {\hat{a}}_{b ( t )} ) + g ] Δ t \\ {\hat{p}}_{t} + {\hat{v}}_{t} Δ t + \frac{1}{2} [ {\hat{R}}_{t} ( {a}_{m} - {\hat{a}}_{b ( t )} ) + g ] Δ {t}^{2} \\ {\hat{R}}_{t} R \{ ( {ω}_{m} - {\hat{ω}}_{b ( t )} ) Δ t \} \\ {\hat{a}}_{b ( t )} \\ {\hat{ω}}_{b ( t )}\end{matrix} ] \\ {\overline{Σ}}_{t + 1} = {F}_{x} {Σ}_{t} {F}_{x}^{T} + {F}_{n} {Q}_{n} {F}_{n}^{T} \\ where & ( 4 ) \\ {F}_{x} = [ \begin{matrix}{I}_{3} & 0 & - {\hat{R}}_{t} [ {a}_{m} - {\hat{a}}_{b ( t )} ] \times Δ t & - {\hat{R}}_{t} Δ t & 0 \\ {I}_{3} Δ t & {I}_{3} & 0 & 0 & 0 \\ 0 & 0 & {R}^{T} \{ ( {ω}_{m} - {\hat{ω}}_{b ( t )} ) Δ t \} & 0 & - {I}_{3} Δ t \\ 0 & 0 & 0 & {I}_{3} & 0 \\ 0 & 0 & 0 & 0 & {I}_{3}\end{matrix} ] \\ {F}_{n} = [ \begin{matrix}{\hat{R}}_{t} & 0 \\ 0 & 0 \\ 0 & {I}_{9}\end{matrix} ] \\ {Q}_{n} = [ \begin{matrix}{( {σ}_{{a}_{n}} Δ t )}^{2} {I}_{3} & 0 & 0 & 0 \\ 0 & {( {σ}_{{ω}_{n}} Δ t )}^{2} {I}_{3} & 0 & 0 \\ 0 & 0 & {( {σ}_{{a}_{w}} Δ t )}^{2} {I}_{3} & 0 \\ 0 & 0 & 0 & {( {σ}_{{ω}_{w}} Δ t )}^{2} {I}_{3}\end{matrix} ] & ( 5 )\end{matrix}$$

### Measurement Update

In this step, a pseudo-pose error measurement δy∈ [symbol] ⁶ is used to update full error state vector δx∈ [symbol] ¹⁵ in a normal KF fashion. δy is called pseudo-measurement because it is not acquired from sensors directly, but recovered using a GPF.

Observation Model: with error state representation, the observation model is simply linear.

$$δ y = H δ x = [ \begin{matrix}0 & {I}_{3} & 0 & 0 & 0 \\ 0 & 0 & {I}_{3} & 0 & 0\end{matrix} ] δ x \qquad ( 6 )$$

Recover Pseudo Measurement: The pseudo-measurement δy can be thought of as being measured by an imaginary sensor. In reality, it is computed by the following steps: first, based on pose priors δx̅ₜ₊₁^{m}∈ [symbol] ⁶, Σ̅ₜ₊₁^{m}∈ [symbol] ^{6×6}, particles (i.e., sample points) are drawn and weighted using the likelihood field model. Second, the pose posterior δxₜ₊₁^{m}∈ [symbol] ⁶, Σₜ₊₁^{m}∈ [symbol] ^{6×6}, is computed as the weighted mean and covariance of the particles. Third, a pseudo-measurement δyₜ₊₁^{m} and pseudo-noise Cₜ₊₁^{m} is recovered by inverse in the KF measurement update.

Cₜ₊₁^{m}=(Σₜ₊₁^{m-1}−(Σ̅ₜ₊₁^{m})⁻¹)⁻¹ (7)

δyₜ₊₁^{m}=(K^{m})⁻¹(δxₜ₊₁^{m}−δx̅ₜ₊₁^{m})+δx̅ₜ₊₁^{m} (8)

where K^{m}=Σ̅ₜ₊₁H^{mT}(H^{m}Σ̅ₜ₊₁H^{mT}+Cₜ₊₁^{m})⁻¹ is the pseudo-Kalman gain.

Correction: Once the pseudo-measurements are computed, they are used to update the full error states by a normal KF update. The Kalman gain is given by equation (9).

K=Σ̅ₜ₊₁H^{T}(HΣ̅ₜ₊₁H^{T}+Cₜ₊₁) (9)

Note that K∈ [symbol] ^{15×6} is different from K∈ [symbol] ^{6×6}. Full error state posterior and covariance are updated as shown in equations (10) and (11).

δxₜ₊₁=K(δyₜ₊₁−Hδx̅ₜ₊₁) (10)

Σₜ₊₁=(I₁₅−KH)Σ̅ₜ₊₁ (11)

### Reset Nominal States

The updated errors are integrated into the normal state by adding the error state to the estimated state, as shown in (12).

$$[ \begin{matrix}{\hat{v}}_{t + 1} \\ {\hat{p}}_{t + 1} \\ {\hat{R}}_{t + 1} \\ {\hat{a}}_{b ( t + 1 )} \\ {\hat{ω}}_{b ( t + 1 )}\end{matrix} ] = [ \begin{matrix}{\hat{v}}_{t} + δ {v}_{t + 1} \\ {\hat{p}}_{t} + δ {p}_{t + 1} \\ {\hat{R}}_{t} \cdot R ( δ {θ}_{t + 1} ) \\ {\hat{a}}_{bt} + δ {a}_{b ( t + 1 )} \\ {\hat{ω}}_{bt} + {δω}_{b ( t + 1 )}\end{matrix} ] \qquad ( 12 )$$

Before the next iteration, the error states are set to zero.

FIG. 1 is a schematic drawing showing the localization process. The ESKF portion takes as input the readings from the IMU. In the motion model box, the IMU acceleration data is integrated to obtain velocity and then integrated again to obtain position, resulting in a rough prediction of the pose of the robot. The measurement update portion takes as input the prior belief and the pseudo-pose measurements derived from the LIDAR data in the GPF portion. The prior belief is based upon the new inputs from the IMU and the previous pose, which has been corrected using the pseudo-measurements derived from the LIDAR data.

The GPF portion of the localization process takes as input LIDAR data and the prior belief from the ESKF motion model. The LIDAR data is sampled based on a probability (the prior belief is a probability) and re-weighted, resulting in a Gaussian distribution representing the robot's position. Because the robot's position is represented as a Gaussian distribution, the robot has a higher likelihood of being in a position close to the mean of the distribution. For each position in the distribution, a weight can be computed based on matching the LIDAR measurement associated with the position to the map. The better the match, the higher the weight which is assigned to the position. A pseudo-measurement is derived from the resulting state, and is used to correct the state in the ESKF portion of the localization process.

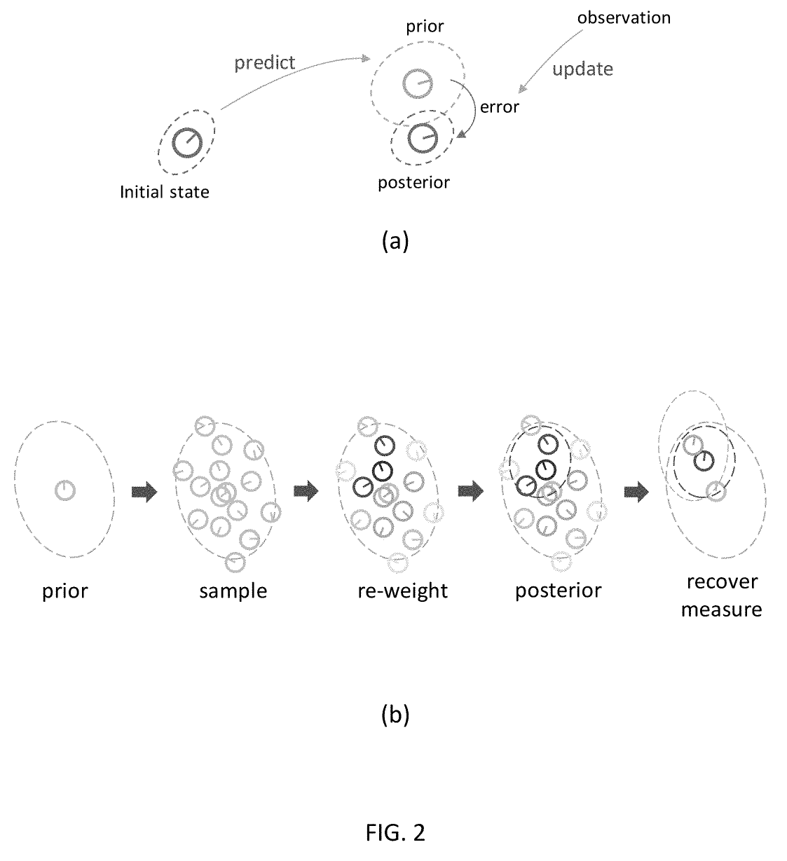

FIG. 2 is a graphic representation of the localization process. FIG. 2(a) graphically shows the ESKF portion of the process. The initial state, \hat{x}ₜ, is represented by a circle, representing the corrected position of the robot from the previous iteration, provided by the feedback loop shown in FIG. 1, with the ellipse representing the uncertainty in the position. Initial state, \hat{x}ₜ is updated with data from the IMU to obtain the prior belief state \overline{\hat{x}}ₜ₊₁ (shown as “Motion Model” in FIG. 1). The ellipse representing the uncertainty in the prior belief state is larger than in the initial state because the IMU data is integrated and introduces more noise into the system. The prior belief state is corrected using the pseudo-measurement, δyₜ₊₁, from the GPF portion of the process (shown as “Measurement Update” in FIG. 1). This results in error state δxₜ₊₁, as well as estimated state \hat{x}ₜ₊₁, which serves as the initial state for the next iteration. Note that the uncertainty in the estimated state after the correction is smaller than the uncertainty in the estimated state prior to the correction.

FIG. 2(b) graphically shows the GPF portion of the localization process. LIDAR data is sampled based upon a probability distribution representing the prior belief from the ESKF portion of the process. The error state of the prior belief is zeroed for each iteration. The sampling of the LIDAR data results in sampling δx₁. Based on the uncertainty, it is possible for the robot to be at any one of the poses within the range of uncertainty. Because the uncertainty is represented by a Gaussian distribution it is probable that the robot is in a position very close to the mean of the distribution. For each particle, we can compute a weight, wᵢ∝P(z|x_{i,m}). In the diagram the darker particles have a higher probability. The weight is computed by matching the LIDAR measurements to the map, wherein better match indicates higher measurement likelihood, and thus is assigned with larger weight. Based on the weighted particles, the weighted mean covariance can be computed, giving another circle and another mean, which is the partial posterior. A pseudo-measurement δyₜ₊₁ is then recovered based on the two ellipses and used in the updating step in the ESKF portion of the process.

### Localizability Analysis

Given a map of the environment, in the form of a point-cloud, it is desirable to be able to determine if the localization will consistently produce accurate results if the robot is in a certain configuration. To accomplish this, the localizability of a given pose in a map is estimated to predict the localization performance. Localizability is a measure of a map's geometric constraints available to a range sensor from a given pose, and tells whether or not the robot will be able to localize from a position.

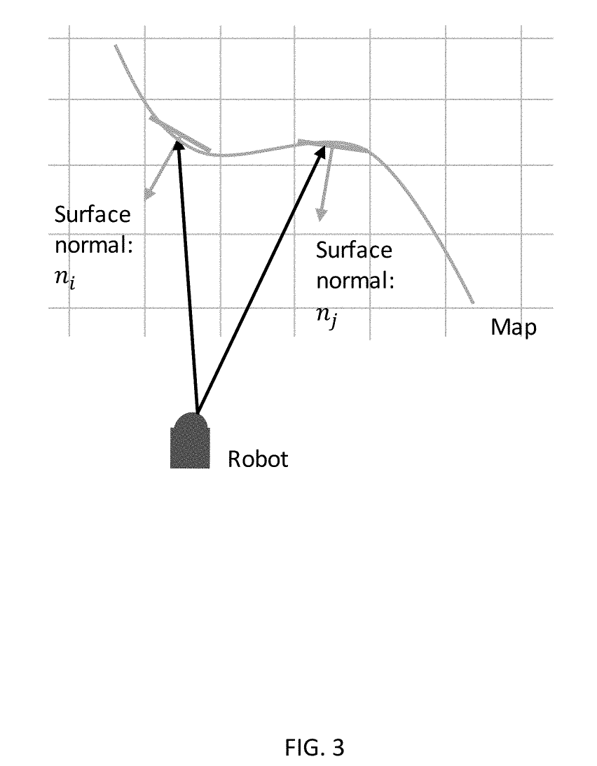

Regions of high localizability should correspond to low state estimation errors and regions of low localizability should correspond to higher state estimation errors. For each point in the map of the environment the value of the localizability metric is checked. The localizability metric is based on the normal distribution of the laser rays hitting the surfaces of the environment. For each laser ray that hits this a surface, it is determined the normal direction with respect to the sensor at that point. This is shown in FIG. 3. To calculate the localization metric, a key assumption is made that for a given point measurement, the corresponding surface normal can be determined based on the map. Surface normals are estimated for every point in the map, and a set of visible points from the given pose is determined, the normals are accumulated and the constraints in each direction are analyzed.

### Position Constraints

Each valid measurement from the sensor provides a constraint on the robot's pose. Specifically, by approximating surfaces as a plane locally, a measurement point pᵢ lying on the plane is constrained by equation (13).

nᵢ^{T}(pᵢ−p_{i,0})=0 (13)

where nᵢ is the surface normal, and p_{i,0} is a point on the plane. Additionally, the sensor measurement provides the offset between the robot's position x and pᵢ as x +rₜᵢ =pᵢ where rᵢ is a ray vector of this measurement. By substitution, equation (13) becomes equation (14).

nᵢ^{T}(x+rᵢ−p_{i,0})=0 [symbol] nᵢ^{T}x=nᵢ^{T}(p_{i,0}−rᵢ)=dᵢ (14)

where dᵢ is a constant vector. Combining all the constraints imposed by a set of measurement points, results in (15)

$$[ \begin{matrix}{n}_{{1}_{x}} & {n}_{{1}_{y}} & {n}_{{1}_{z}} \\ {n}_{{2}_{x}} & {n}_{{2}_{y}} & {n}_{{2}_{z}} \\ ⋮ & ⋮ & ⋮ \\ {n}_{{k}_{x}} & {n}_{{k}_{y}} & {n}_{{k}_{z}}\end{matrix} ] \\ x = [ \begin{matrix}{d}_{1} \\ {d}_{2} \\ ⋮ \\ {d}_{k}\end{matrix} ] ⇒ Nx = D \qquad ( 15 )$$

### Evaluating Localizability

To accurately localize the robot, the sensor needs to be able to adequately constrain its pose in the three translational dimensions. The matrix N describes the set of observable constraints from the given pose. Preforming a principal component analysis (PCA) on the row vectors of N provides an orthonormal basis spanning the space described by the constraints from the surface normals. Furthermore, the singular values of N can be examined with SVD as UΣV^{T}. Where Σ describes the cumulative strength of the constraints form each corresponding basis vector. Theoretically, localization should be possible as long as all three of the singular values are non-zero. However, this proves to be unreliable in practice so localizability is calculated as the minimum singular value of N. More specifically: L−min(diag(Σ)). This sets localizability equal to the strength of the constraints in the minimally constrained direction, based on the visibility of surface normals. Furthermore, this analysis also allows for the determination of the minimally constrained direction as the singular vector corresponding to the minimal singular value.

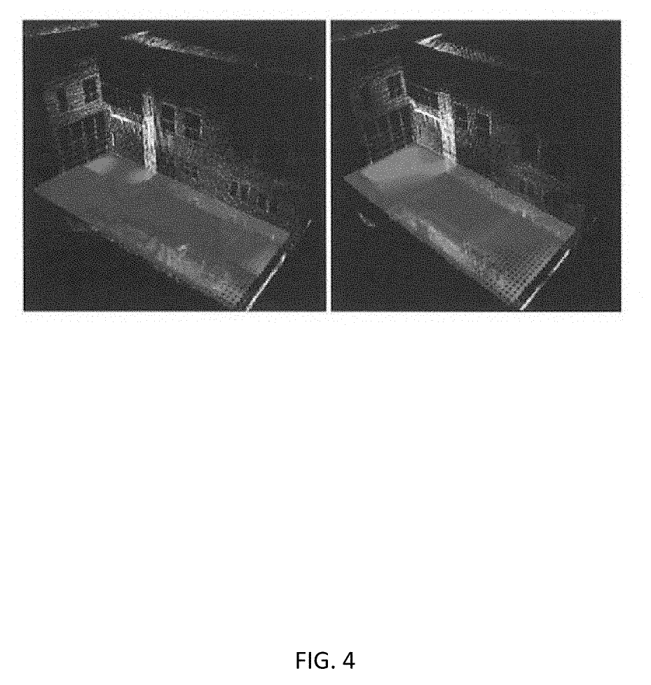

FIG. 4 shows localizability in a real-life environment, where red dots indicate more localizability and blue dots indicate less localizability. As such, near the edges the robot knows where it is, but in the middle it gets lost because it only sees one wall and the ground, but doesn't see anything to the left and the right.

The described method and system represents a robust localization approach fusing IMU and laser range data into an ESKF framework. The algorithm is robust in various environments with different characteristics and scale. Additionally, a new approach to model localizability and predict localization performance based on environmental geometry is described.

We claim:

1. A method for localizing a robot comprising:
a. obtaining a reading from an inertial measurement unit on the robot;
b. updating a previous state of the robot with the reading from the inertial measurement unit to produce an estimated state;
c. correcting the estimated state using a pseudo-measurement derived from data from a LIDAR unit on the robot; and
d. repeating steps a-d using the corrected estimated state as the previous state for the next iteration;
e. obtaining a point cloud reading from a LIDAR unit on the robot;
f. sampling the point cloud based on the estimated state;
g. weighting each sampled point from the point cloud to produce a probability distribution representing the robot's position;
h. computing a weighted mean and covariance of the probability distribution to provide a partial posterior state of the robot;
i. deriving the pseudo-measurement from the partial posterior state; and
j. repeating steps e-j.

2. The method of claim 1 wherein the state of the robot includes at least a robot position, an orientation of the robot and a velocity of the robot.

3. The method of claim 1 wherein the weight for each sampled point from the point cloud is computed based on matching the LIDAR measurement associated with the position to a map.

4. The method of claim 1 wherein the step of correcting the estimated state comprises computing an error state based on a difference between the estimated state and the pseudo-measurements derived from the LIDAR unit and applying the error state to the estimated state.

5. The method of claim 1 wherein the pseudo-measurements comprise pseudo-pose information and pseudo-noise information.

6. The method of claim 1 wherein the error state is zeroed prior to the next iteration of steps a-d.

7. A method for predicting the localizability of a robot at a given pose comprising:
a. obtaining a point cloud reading from a LIDAR unit on the robot;
b. estimating surface normals for every point in a map representing the environment of the robot;
c. determining a set of visible points from the given pose;
d. analyzing the constraints in each direction based on the surface normals; and
e. creating a localizability metric for the given pose based on the strength of the constraints in the minimally constrained direction.

8. The method of claim 7 when the localizability metric is calculated for each point in the map of the environment.

9. The method of claim 7 wherein the localizability for the given pose can be predicted if the robot can be constrained in three translational dimensions.

10. The method of claim 7 wherein the step of creating a localizability metric further comprises;
a. creating a matrix describing the set of observable constraints from the given pose;
b. performing a principal component analysis on the row vectors of the matrix to provide an orthonormal basis spanning the space described by the constraints from the surface normals; and
c. calculating localizability as the minimum singular value of the matrix.

11. A system for localizing a robot comprising:
an inertial measurement unit, mounted on the robot;
a LIDAR unit, mounted on the robot;
a processor in communication with the inertial measurement unit and the LIDAR unit, the processor executing code stored in a memory for performing the functions of:
a. obtaining a reading from the inertial measurement unit;
b. updating a previous state of the robot with the reading from the inertial measurement unit to produce an estimated state;
c. correcting the estimated state using a pseudo-measurement derived from data from the LIDAR unit; and
d. repeating steps a-d using the corrected estimated state as the previous state for the next iteration;
e. obtaining a point cloud reading from the LIDAR unit;
f. sampling the point cloud based on the estimated state;
g. weighting each sampled point from the point cloud to produce a probability distribution representing the robot's position;
h. computing a weighted mean and covariance of the probability distribution to provide a partial posterior state of the robot;
i. deriving the pseudo-measurement from the partial posterior state; and
j. repeating steps e-j.

12. The system of claim 11 wherein the state of the robot includes at least a robot position, an orientation of the robot and a velocity of the robot.

13. The system of claim 11 wherein the weight for each sampled point from the point cloud is computed based on matching the LIDAR measurement associated with the position to a map.

14. The system of claim 11 wherein the step of correcting the estimated state comprises computing an error state based on a difference between the estimated state and the pseudo-measurements derived from the LIDAR unit and applying the error state to the estimated state.

15. The system of claim 11 wherein the pseudo-measurements comprise pseudo-pose information and pseudo-noise information.

16. The system of claim 11 wherein the error state is zeroed prior to the next iteration of steps a-d.

17. A system for predicting the localizability of a robot at a given pose comprising:
a LIDAR unit, mounted on the robot;
a processor in communication with the LIDAR unit, the processor executing code stored in a memory for performing the functions of:
a. obtaining a point cloud reading from the LIDAR unit;
b. estimating surface normals for every point in a map representing the environment of the robot;
c. determining a set of visible points from the given pose;
d. analyzing the constraints in each direction based on the surface normals; and
e. creating a localizability metric for the given pose based on the strength of the constraints in the minimally constrained direction.

18. The system of claim 17 when the localizability metric is calculated for each point in the map of the environment.

19. The system of claim 17 wherein the localizability for the given pose can be predicted if the robot can be constrained in three translational dimensions.

20. The system of claim 17 wherein the step of creating a localizability metric further comprises;
a. creating a matrix describing the set of observable constraints from the given pose;
b. performing a principal component analysis on the row vectors of the matrix to provide an orthonormal basis spanning the space described by the constraints from the surface normals; and
c. calculating localizability as the minimum singular value of the matrix.
